(19) United States
(12) Patent Application Publication
(10) Pub. No.: US 2024/0013353 A1
(43) Pub. Date: Jan. 11, 2024

(54) DISPLAY APPARATUS AND DISPLAY METHOD

(71) Applicant: HTC Corporation, Taoyuan City (TW)

(72) Inventors: Sheng-Yan Lin, Taoyuan City (TW); Chung-Yi Wang, Taoyuan City (TW); Li-Wei Lin, Taoyuan City (TW)

(73) Assignee: HTC Corporation, Taoyuan City (TW)

(21) Appl. No.: 18/323,415

(22) Filed: May 25, 2023

Related U.S. Application Data
(60) Provisional application No. 63/367,724, filed on Jul. 6, 2022.

(51) Int. Cl. G06T 5/00; G06T 5/50; G09G 3/20

(52) U.S. Cl. CPC G06T 5/006; G06T 5/50; G09G 3/2092; G06T 2207/10024; G06T 2207/20212; G09G 2340/045

(57) ABSTRACT

A display apparatus is provided. The display apparatus includes a graphic processing unit, a display driver, and a display panel. The graphic processing unit is configured to provide a first image. The display driver is configured to correct an optical aberration of the first image to generate a second image. The display panel is configured to display the second image.

### CROSS-REFERENCE TO RELATED APPLICATION

This application claims the priority benefit of U.S. provisional application Ser. No. 63/367,724, filed on Jul. 6, 2022. The entirety of the above-mentioned patent application is hereby incorporated by reference herein and made a part of this specification.

### BACKGROUND

### Technical Field

The disclosure relates to a display apparatus; particularly, the disclosure relates to a display apparatus and a display method.

### Description of Related Art

When light passes through an optical system (such as lenses), it can be refracted or reflected, causing the light rays to converge at a focal point. However, due to the shape and materials of the lens, not all of the light rays will converge at the same point, resulting in various optical aberrations such as chromatic aberration and distortion. In products with the optical systems, in order to display images correctly, these optical aberrations must be corrected. These optical aberrations may be corrected through the use of specialized lens design in advance or may be corrected by correction calculations afterward.

### SUMMARY

The disclosure is direct to a display apparatus and a display method, so as to reduce the cost of a display apparatus.

In this disclosure, a display apparatus is provided. The display apparatus includes a graphic processing unit, a display driver, and a display panel. The graphic processing unit is configured to provide a first image. The display driver is configured to correct an optical aberration of the first image to generate a second image. The display panel is configured to display the second image.

In this disclosure, a display method is provided. The display method includes: receiving a first image from a graphic processing unit; correcting, by a display driver, an optical aberration of the first image to generate a second image; and displaying, by a display panel, the second image.

Based on the above, according to the display apparatus and the display method, by correcting the optical aberration by the display driver, the loading of the graphic processing unit is reduced, thereby reducing the cost and requirement of the graphic processing unit and improving the performance of the display apparatus.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic diagram of a display apparatus according to an embodiment of the disclosure.

FIG. 2 is a schematic diagram of a display driver according to an embodiment of the disclosure.

FIG. 3 is a schematic diagram of a data flow of a display driver according to an embodiment of the disclosure.

FIG. 4 is a schematic diagram of a data flow of a display driver according to an embodiment of the disclosure.

FIG. 5 is a schematic flowchart of a display method according to an embodiment of the disclosure.

### DESCRIPTION OF THE EMBODIMENTS

Reference will now be made in detail to the exemplary embodiments of the disclosure, examples of which are illustrated in the accompanying drawings. Whenever possible, the same reference numbers are used in the drawings and the description to refer to the same or like components.

Certain terms are used throughout the specification and appended claims of the disclosure to refer to specific components. Those skilled in the art should understand that electronic device manufacturers may refer to the same components by different names. This article does not intend to distinguish those components with the same function but different names. In the following description and rights request, the words such as “comprise” and “include” are open-ended terms, and should be explained as “including but not limited to . . . ”.

The term “coupling (or connection)” used throughout the whole specification of the present application (including the appended claims) may refer to any direct or indirect connection means. For example, if the text describes that a first device is coupled (or connected) to a second device, it should be interpreted that the first device may be directly connected to the second device, or the first device may be indirectly connected through other devices or certain connection means to be connected to the second device. The terms “first”, “second”, and similar terms mentioned throughout the whole specification of the present application (including the appended claims) are merely used to name discrete elements or to differentiate among different embodiments or ranges. Therefore, the terms should not be regarded as limiting an upper limit or a lower limit of the quantity of the elements and should not be used to limit the arrangement sequence of elements. In addition, wherever possible, elements/components/steps using the same reference numerals in the drawings and the embodiments represent the same or similar parts. Reference may be mutually made to related descriptions of elements/components/steps using the same reference numerals or using the same terms in different embodiments.

It should be noted that in the following embodiments, the technical features of several different embodiments may be replaced, recombined, and mixed without departing from the spirit of the disclosure to complete other embodiments. As long as the features of each embodiment do not violate the spirit of the disclosure or conflict with each other, they may be mixed and used together arbitrarily.

When light passes through an optical system (such as lenses), it can be refracted or reflected, causing the light rays to converge at a focal point. However, due to the shape and materials of the lens, not all of the light rays will converge at the same point, resulting in various optical aberrations such as chromatic aberration and distortion. In products with the optical systems, in order to display images correctly, these aberrations must be corrected. These optical aberrations may be corrected through the use of specialized lens design in advance or may be corrected by correction calculations afterward.

The correction calculations for the optical aberrations are usually performed within a source system integrated circuit (system IC) (e.g., by the graphic processing unit (GPU)) of a source system of a display apparatus, which means that the system IC must allocate some resource for the correction calculation, thereby occupying the computing power of the system IC. Therefore, if some of the correction calculations can be performed outside the system IC, the loading of the system IC may be reduced and the requirement of the system IC may be lowered, thereby also reducing the cost of the system IC of the display apparatus.

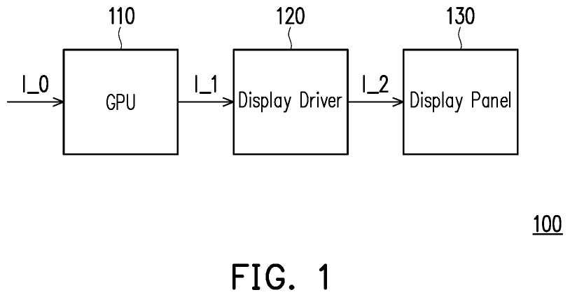

FIG. 1 is a schematic diagram of a display apparatus according to an embodiment of the disclosure. With reference to FIG. 1, a display apparatus 100 may include a graphic processing unit 110, a display driver 120, and a display panel 130. The graphic processing unit 110 may be coupled to the display driver 120 and the display driver 120 may be coupled to the display panel 130. The graphic processing unit 110 may be configured to provide a first image I_1. The display driver 120 may be coupled to the graphic processing unit 110 and the display driver 120 may be configured to correct an optical aberration of the first image I_1 to generate a second image I_2. The display panel 130 may be coupled to the display driver 120 and the display panel 130 may be configured to display the second image I_2. In this manner, some of the correction calculation for optical aberrations can be performed by the display driver 120, thereby reducing the loading of the graphic processing unit 110 and the cost of the display apparatus 100.

In one embodiment, the display apparatus 100 may be configured to provide immersive experience of augmented reality (AR), virtual reality (VR), mixed reality (MR), or Extended Reality (XR), but this disclosure is not limited thereto.

In one embodiment, the graphic processing unit 110 may be disposed in a source system of the display apparatus 100 and the source system may be achieved by a source system integrated circuit (System IC). In one embodiment, the graphic processing unit 110, includes, for example, a microcontroller unit (MCU), a central processing unit (CPU), a microprocessor, a digital signal processor (DSP), a programmable controller, a programmable logic device (PLD), other similar devices, or a combination of the devices. However, this disclosure is not limited thereto.

In one embodiment, the display driver 120 may be disposed in a display of the display apparatus 100 and the display driver 120 achieved by one or more circuits, but this disclosure is not limited thereto. For example, the display driver 120 may be achieved by a display driver integrated circuit (DDIC) in the display, but this disclosure is not limited thereto. Further, the computing power of the graphic processing unit 110 may be greater than the computing power of the display driver 120, but this disclosure is not limited thereto.

In one embodiment, the display of the display apparatus may be configured to display content of augmented reality (AR), virtual reality (VR), mixed reality (MR), or Extended Reality (XR). For example, the display may be included in a head-mounted display (HMD), wearable glasses (e.g., AR/VR goggles), a tablet, a smartphone, a projector, a laptop, other similar devices adapted for AR, VR, MR, XR or other reality related technologies, or a combination of these devices. However, this disclosure is not limited thereto.

In one embodiment, the display panel 130 may be disposed in the display of the display apparatus 100 and the display panel 130 includes, for example, an organic light-emitting diode (OLED) display panel, a mini LED display panel, a micro LED display panel, a quantum dot (QD) LED display panel, a liquid-crystal display (LCD) display panel, a tiled display panel, a foldable display panel, or an electronic paper display (EPD) panel. However, the disclosure is not limited thereto.

In one embodiment, the display apparatus 100 may be coupled to an optical system (such as lenses) to receive an original image I_0. Further, the graphic processing unit 110 may be configured to correct a distortion of the original image I_0 caused by the optical system to generate the first image I_1. Furthermore, the display driver 120 may be configured to correct a chromatic aberration of the first image I_1 caused by the optical system to generate the first image I_2. In other words, the optical aberration may include the chromatic aberration caused by the optical system. Further, the original image I_0, the first image I_1, and the second image I_2 may relate to content of augmented reality (AR), virtual reality (VR), mixed reality (MR), or Extended Reality (XR), but this disclosure is not limited thereto.

In one embodiment, the optical system may be included in a head-mounted display (HMD), wearable glasses (e.g., AR/VR goggles), a tablet, a smartphone, a projector, a laptop, other similar devices adapted for AR, VR, MR, XR or other reality related technologies, or a combination of these devices. However, this disclosure is not limited thereto.

It is noted that, the display driver 120 may include built-in image processing functions. For example, the built-in processing functions may include at least one of a gamma correction function, a size scaling function, a color correction function, a contrast adjustment function, a noise reduction function, and a backlight control function, but this disclosure is not limited thereto. However, if the chromatic aberration is corrected by the graphic processing unit 110, the relative positions between pixels of the original image I_0 will be changed. That is, if the chromatic aberration is corrected by the graphic processing unit 110, the display driver 120 may not be able to perform the built-in image processing functions properly.

In this disclosure, instead of performing the chromatic aberration by the graphic processing unit 110, by arranging performing the chromatic aberration after performing the built-in image processing functions of the display driver 120, the built-in image processing functions of the display driver 120 may still be performed properly. That is, the display driver 120 may be configured to perform build-in image processing functions to the first image Ii before correcting the optical aberration of the first image Ii. In one embodiment, the chromatic aberration may be performed by utilizing the size scaling function of the built-in image processing functions. That is, no extra circuit is needed to be added in the display driver 120. However, in another embodiment, an extra circuit may be added to correct the chromatic aberration of the first image I_1, and this disclosure is not limited thereto. Further, since the display driver 120 is able to perform the built-in image processing functions, some of the image processing of the original image I_0 may be performed by the display driver 120 instead of by the graphic processing unit 110, thereby reducing the loading of the graphic processing unit 110 and enabling the graphic processing unit 110 to process other function of the display apparatus 100. Therefore, the performance of the display apparatus 100 may be increased.

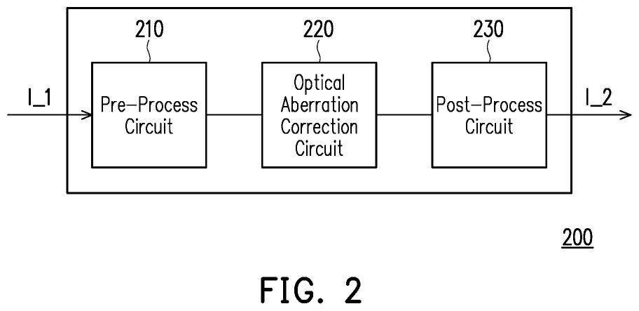

FIG. 2 is a schematic diagram of a display driver according to an embodiment of the disclosure. With reference to FIG. 1 and FIG. 2, a display driver 200 is an exemplary embodiment of the display driver 120 of the display apparatus 100, but this disclosure is not limited thereto. The display driver 200 may include a pre-process circuit 210, an optical aberration correction circuit 220, and a post-process circuit 230. The pre-process circuit 210 may be coupled to the optical aberration correction circuit 220 and the optical aberration correction circuit 220 may be coupled to the post-process circuit 230.

In one embodiment, the pre-process circuit 210 may be configured to receive the first image I_0 from the graphic processing unit 110. Further, the pre-process circuit 210 may be configured to perform at least one of the build-in image processing functions to the first image I_1. Furthermore, the optical aberration correction circuit 220 may be configured to perform the optical aberration correction to the first image I_1 to generate the second image I_2. Moreover, the post-process circuit 230 may be configured to perform at least one of the build-in image processing functions to the second image I_2.

In this manner, before performing the optical aberration correction to the first image I_1 by the optical aberration correction circuit 220, the pre-process circuit 210 is able to perform at least one of the build-in image processing functions of the display driver 200 to the first image I_1 first. Therefore, the build-in image processing functions of the display driver 200 may be properly and effectively used and the loading of the graphic processing unit 110 may be decreased.

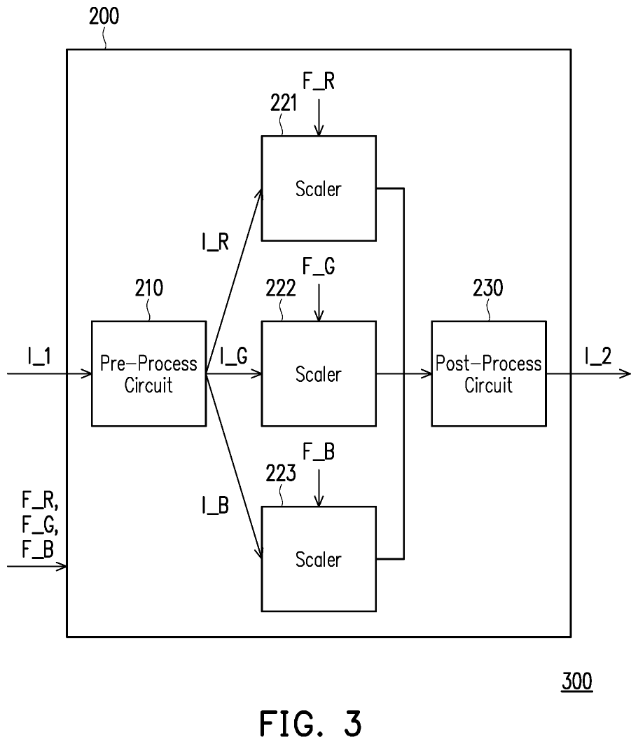

FIG. 3 is a schematic diagram of a data flow of a display driver according to an embodiment of the disclosure. With reference to FIG. 1 to FIG. 3, a data flow 300 is an exemplary embodiment of a data flow of the display driver 200, but this disclosure is not limited thereto. Further, each of three scalers 221, 222, 223 is an exemplary embodiment of the optical aberration correction circuit 220, but this disclosure is not limited thereto. The pre-processing circuit 210 may be coupled to each of the three scalers 221, 222, 223 and each of the three scalers 221, 222, 223 may be coupled to the post-process circuit 230.

In one embodiment, the first image I_1 may include a first red image I_R, a first green image I_G, and a first blue image I_B. The display driver 200 may be configured to extract the first red image I_R, the first green image I_G, and the first blue image I_B from the first image I_1. Further, the display driver 200 may be configured to perform the optical aberration correction to the first red image I_R, the first green image I_G, and the first blue image I_B, respectively.

In one embodiment, the pre-process circuit 210 may be configured to extract the first red image I_R, the first green image I_G, and the first blue image I_B from the first image I_1. Further, the optical aberration correction circuit 220 may be configured to perform the optical aberration correction to the first red image I_R, the first green image I_G, and the first blue image I_B to generate a second red image, a second green image, and a second blue image, respectively. Furthermore, the post-process circuit 230 may be configured to generate the second image I_2 by combining the second red image, the second green image, and the second blue image. Moreover, the pre-process circuit 210 may be configured to perform one of the built-in image processing functions of the display driver 200 to the first red image I_R, the first green image I_G, and the first blue image I_B. In addition, the post-process circuit 230 may be configured to perform one of the built-in image processing functions of the display driver 200 to the second red image, the second green image, and the second blue image.

In one embodiment, the graphic processing unit 110 may be configured to receive an original image I_0 from an optical system. Further, the graphic processing unit 110 may be configured to generate optical aberration factors based on the original image I_0 and provide the optical aberration factors to the display driver 200. Furthermore, the display driver 200 may be configured to perform the optical aberration correction based on the optical aberration factors. That is, since the computer power of the graphic processing unit 110 may be stronger than the computer power of the display driver 200, the optical aberration factors may be calculated by the graphic processing unit 110 and provide to the display driver 200 to achieve better efficiency. For example, the optical aberration factors may include a red factor F_R, a green factor F_G, and a blue factor F_B.

In one embodiment, the display driver 200 may include three scalers 221, 222, 223 and each of the three scalers 221, 222, 223 may be able to perform a size scaling function to achieve the optical aberration correction. The size scaling function may be one of the built-in image processing function of the display driver 200, but this disclosure is not limited thereto. Further, the three scalers 221, 222, 223 may be configured to perform the optical aberration correction based on the red factor F_R, the green factor F_G, and the blue factor F_B, respectively. For example, the scaler 221 may be configured to perform the optical aberration correction to the first red image I_R based on the red factor F_R, the scaler 222 may be configured to perform the optical aberration correction to the first green image I_G based on the green factor F_G, and the scaler 223 may be configured to perform the optical aberration correction to the first blue image I_B based on the blue factor F_B. In this manner, the optical aberration correction is performed by the display driver 200, thereby reducing the loading of the graphic processing unit 110.

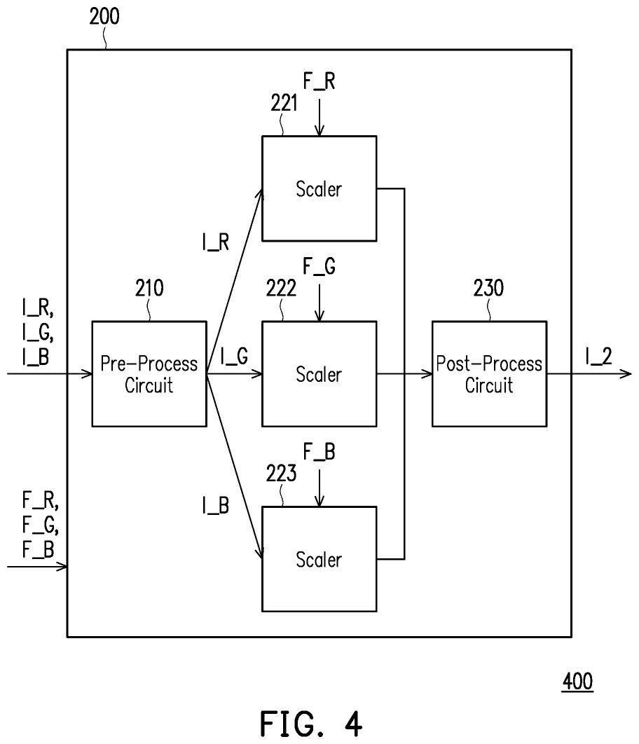

FIG. 4 is a schematic diagram of a data flow of a display driver according to an embodiment of the disclosure. With reference to FIG. 1 to FIG. 4, a data flow 400 is an exemplary embodiment of a data flow of the display driver 200, but this disclosure is not limited thereto. Comparing with the data flow 300 of FIG. 3, instead of extracting the first red image I_R, the first green image I_G, and the first blue image I_B by the display driver 200, in the data flow 400 of FIG. 4, the graphic processing unit 110 may be configured to extract the first red image I_R, the first green image I_G, and the first blue image I_B from the first image and provide the first red image I_R, the first green image I_G, and the first blue image I_B as the first image I_1 to the display driver 200.

For example, the graphic processing unit 110 may be configured to provide the first red image I_R, the first green image I_G, and the first blue image I_B sequentially in a streaming manner. That is, the graphic processing unit 110 may be configured to provide the first red image I_R first, provide the first green image I_G after providing the first red image I_R, and provide the first blue image I_B after providing the first green image I_B. However, the sequence of the providing the first red image I_R, the first green image I_G, and the first blue image I_B to the display driver 200 by the graphic processing unit 110 is not limited thereto.

After receiving the first red image I_R, the first green image I_G, and the first blue image I_B from the graphic processing unit 110, the display driver 200 may be configured to perform the optical aberration correction to the first red image I_R, the first green image I_G, and the first blue image I_B, respectively. In one embodiment, the pre-process circuit 210 may be configured to receive the first red image I_R, the first green image I_G, and the first blue image I_B sequentially from the graphic processing unit 110. Further, the optical aberration correction circuit 220 may be configured to receive the first red image I_R, the first green image I_G, and the first blue image I_B sequentially from the pre-process circuit 210. That is, the the pre-process circuit 210 may act as an interface circuit to transmits signals, but this disclosure is not thereto. In another embodiment, the pre-process circuit 210 may be further configured to decompress signals (e.g., the first red image I_R, the first green image I_G, and the first blue image I_B) from the graphic process unit 110 and to one of the built-in image processing functions of the display driver 200 to the first red image I_R, the first green image I_G, and the first blue image I_B. Furthermore, the optical aberration correction circuit 220 may be configured to perform the optical aberration correction to the first red image I_R, the first green image I_G, and the first blue image I_B sequentially to generate a second red image, a second green image, and a second blue image, respectively. In addition, the post-process circuit 230 may be configured to generate the second image I_2 by combining the second red image, the second green image, and the second blue image.

That is, the first red image I_R, the first green image I_G, and the first blue image I_B may be also provided to the optical aberration correction circuit 220 in a streaming manner. In other words, once the first red image I_R is received (while the first green image I_G is yet not received), the optical aberration correction circuit 220 is able to perform the optical aberration correction to the first red image I_R to generate the second red image. Further, once the first green image I_G is received (while the first blue image I_B is yet not received), the optical aberration correction circuit 220 is able to perform the optical aberration correction to the first green image I_G to generate the second green image. Lastly, once the first blue image I_B is received, the optical aberration correction circuit 220 is able to perform the optical aberration correction to the first blue image I_B to generate the second blue image. In this manner, the time of performing the optical aberration correction may be reduced, thereby increasing the user experience.

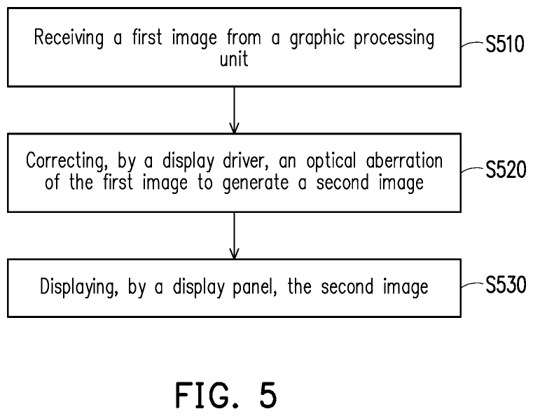

FIG. 5 is a schematic flowchart of a display method according to an embodiment of the disclosure. With reference to FIG. 1 to FIG. 5, a display method includes a step S510, a step S520, and a step S530. In the step S510, the display driver 120 may be configured to receive the first image I_1 from the graphic processing 110. In the step S520, the display driver 120 may be configured to correct the optical aberration of the first image I_1 to generate the second image I_2. In the step S530, the display panel 130 may be configured to display the second image I_2.

In addition, the implementation details of the display method 500 may be referred to the descriptions of FIG. 1 to FIG. 4 to obtain sufficient teachings, suggestions, and implementation embodiments, while the details are not redundantly described seriatim herein.

In summary, according to the display apparatus 100 and the display method 500, by correcting the chromatic aberration by the display driver 120, the loading of the graphic processing unit 110 is reduced, thereby reducing the cost and requirement of the graphic processing unit 110 and improving the performance of the display apparatus 100.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A display apparatus, comprising:
a graphic processing unit, configured to provide a first image;
a display driver, configured to correct an optical aberration of the first image to generate a second image, wherein the optical aberration comprises a chromatic aberration caused by an optical system; and
a display panel, configured to display the second image.

2. The display apparatus according to claim 1, wherein
the graphic processing unit is configured to correct a distortion of an original image caused by the optical system to generate the first image.

3. The display apparatus according to claim 1, wherein the display driver is configured to:
extract a first red image, a first green image, and a first blue image from the first image; and
perform the optical aberration correction to the first red image, the first green image, and the first blue image, respectively.

4. The display apparatus according to claim 1, wherein
the graphic processing unit is configured to:
extract a first red image, a first green image, and a first blue image from the first image; and
provide the first red image, the first green image, and the first blue image as the first image to the display driver, and
the display driver is configured to:
perform the optical aberration correction to the first red image, the first green image, and the first blue image, respectively.

5. The display apparatus according to claim 1, wherein the display driver comprises:
a pre-process circuit, configured to:
extract a first red image, a first green image, and a first blue image from the first image;
an optical aberration correction circuit, configured to:
perform the optical aberration correction to the first red image, the first green image, and the first blue image to generate a second red image, a second green image, and a second blue image, respectively; and
a post-process circuit, configured to:
generate the second image by combining the second red image, the second green image, and the second blue image.

6. The display apparatus according to claim 1, wherein the display driver comprises:
a pre-process circuit, configured to:
receive a first red image, a first green image, and a first blue image sequentially from the graphic processing unit;
an optical aberration correction circuit, configured to:
receive the first red image, the first green image, and the first blue image sequentially from the pre-process circuit; and
perform the optical aberration correction to the first red image, the first green image, and the first blue image sequentially to generate a second red image, a second green image, and a second blue image, respectively; and
a post-process circuit, configured to:
generate the second image by combining the second red image, the second green image, and the second blue image.

7. The display apparatus according to claim 1, wherein
the graphic processing unit is configured to:
receive an original image from the optical system;
generate optical aberration factors based on the original image; and
provide the optical aberration factors to the display driver, and
the display driver is configured to:
perform the optical aberration correction based on the optical aberration factors.

8. The display apparatus according to claim 7, wherein
the optical aberration factors comprises a red factor, a green factor, and a blue factor.

9. The display apparatus according to claim 8, wherein
the display driver comprises three scalers and the three scalers are configured to perform the optical aberration correction based on the red factor, the green factor, and the blue factor, respectively.

10. The display apparatus according to claim 1, wherein
the display driver is configured to perform build-in image processing functions to the first image before correcting the optical aberration of the first image.

11. The display apparatus according to claim 10, wherein
the build-in image processing functions comprise at least one of a gamma correction function, a size scaling function, a color correction function, a contrast adjustment function, a noise reduction function, and a backlight control function.

12. The display apparatus according to claim 11, wherein
the display driver is configured to correct the optical aberration of the first image utilizing the size scaling function of the built-in image processing functions of the display driver.

13. A display method, comprising:
receiving a first image from a graphic processing unit;
correcting, by a display driver, an optical aberration of the first image to generate a second image, wherein the optical aberration comprises a chromatic aberration caused by an optical system; and
displaying, by a display panel, the second image.

14. The display method according to claim 13, further comprising:
correcting, by the graphic processing unit, a distortion of an original image caused by the optical system to generate the first image.

15. The display method according to claim 13, further comprising:
extracting a first red image, a green image, and a first blue image from the first image; and
performing, by the display driver, the optical aberration correction to the first red image, the first green image, and the first blue image, respectively.

16. The display method according to claim 13, further comprising:
receiving an original image from the optical system;
generating, by the graphic processing unit, optical aberration factors based on the original image; and
performing, by the display driver, the optical aberration correction based on the optical aberration factors.

17. The display method according to claim 16, wherein
the optical aberration factors comprises a red factor, a green factor, and a blue factor.

18. The display method according to claim 17, wherein
the display driver comprises three scalers and the three scalers are configured to perform the optical aberration correction based on the red factor, the green factor, and the blue factor, respectively.

19. The display method according to claim 13, further comprising:
performing, by the display driver build-in image processing functions to the first image before correcting the optical aberration of the first image.

20. The display method according to claim 19, wherein
the build-in image processing functions comprise at least one of a gamma correction function, a size scaling function, a color correction function, a contrast adjustment function, a noise reduction function, and a backlight control function.
